(19) United States
(12) Patent Application Publication
(10) Pub. No.: US 2021/0295162 A1
(43) Pub. Date: Sep. 23, 2021

(54) NEURAL NETWORK MODEL TRAINING METHOD AND APPARATUS, COMPUTER DEVICE, AND STORAGE MEDIUM

(71) Applicant: PING AN TECHNOLOGY(SHENZHEN)CO.,LTD., Shenzhen (CN)

(72) Inventors: Yan GUO, Shenzhen (CN); Bin LV, Shenzhen (CN); Chuanfeng LV, Shenzhen (CN); Guotong XIE, Shenzhen (CN)

(73) Assignee: PING AN TECHNOLOGY(SHENZHEN)CO.,LTD., Shenzhen (CN)

(21) Appl. No.: 17/264,307

(22) PCT Filed: May 30, 2019
(86) PCT No.: PCT/CN2019/089194

§ 371 Date: Jan. 29, 2021

(30) Foreign Application Priority Data
Jan. 4, 2019 (CN) 201910008317.2

(51) Int. Cl. G06N 3/08; G06N 3/04

(52) U.S. Cl. CPC G06N 3/08; G06N 3/04

(57) ABSTRACT

A neural network model training method and apparatus, a computer device, and a storage medium are provided. The method includes: obtaining a model prediction value of each of all reference samples based on a trained deep neural network model, calculating a difference measurement index between the model prediction value of each reference sample and a real annotation corresponding to the reference sample, and using a target reference sample whose difference measurement index is less than or equal to a preset threshold as a comparison sample; using a training sample whose similarity with the comparison sample meets a preset augmentation condition as a to-be-augmented sample; and performing data augmentation on the to-be-augmented sample, and using the obtained target training sample as a training sample to train the trained deep neural network model until model prediction values of all verification samples in a verification set meet a preset training ending condition.

### CROSS REFERENCE TO THE RELATED APPLICATIONS

This application is the national phase entry of International Application No. PCT/CN2019/089194, filed on May 30, 2019, which is based upon and claims priority to Chinese Patent Application No. 201910008317.2, filed on Jan. 4, 2019, the entire contents of which are incorporated herein by reference.

### TECHNICAL FIELD

This application relates to the field of neural networks, and in particular, to a neural network model training method and apparatus, a computer device, and a storage medium.

### BACKGROUND

Currently, a deep learning algorithm plays an important function in the development of computer vision applications, and the deep learning algorithm has certain requirements for training data. When the amount of training data is insufficient, the fitting effect of the low-frequency hard example is poor. Based on the foregoing situation, conventionally, some training methods for mining hard samples have been proposed, low-frequency and underfit samples in a training set are retained, and high-frequency and easy-to-identify samples are removed, thereby simplifying the training set and improving training pertinence. However, the inventors realize that in the foregoing conventional solution, on the one hand, training data in the training set is reduced, which is not conducive to model training; on the other hand, even if the training data is augmented or supplemented, it is difficult to improve the pertinence of the training data in model training, and it is impossible to directly analyze missing samples in the model training process, that is, the hard samples. As a result, the pertinence and training efficiency of the foregoing conventional training method are relatively low.

### SUMMARY

This application provides a neural network model training method and apparatus, a computer device, and a storage medium, so as to select pertinent training samples, and improve pertinence and training efficiency of model training.

A neural network model training method, including: training a deep neural network model based on training samples in a training set to obtain a trained deep neural network model; performing data verification on all reference samples in a reference set based on the trained deep neural network model to obtain a model prediction value of each of all the reference samples, where the reference set includes a verification set and/or a test set; calculating a difference measurement index between the model prediction value of each reference sample and a real annotation corresponding to the reference sample, where each reference sample is pre-annotated; using each target reference sample whose difference measurement index is less than or equal to a preset threshold in all the reference samples as a comparison sample; calculating a similarity between each training sample in the training set and each comparison sample; using a training sample whose similarity with the comparison sample meets a preset augmentation condition as a to-be-augmented sample; performing data augmentation on the to-be-augmented sample to obtain a target training sample; and training the trained deep neural network model by using the target training sample as a training sample in the training set until model prediction values of all verification samples in the verification set meet a preset training ending condition.

A neural network model training apparatus, including: a training module, configured to train a deep neural network model based on training samples in a training set to obtain a trained deep neural network model; a verification module, configured to perform data verification on all reference samples in a reference set based on the trained deep neural network model obtained by the training module to obtain a model prediction value of each of all the reference samples, where the reference set includes a verification set and/or a test set; a first calculation module, configured to calculate a difference measurement index between the model prediction value of each reference sample and a real annotation corresponding to the reference sample, where each reference sample is pre-annotated; a first determining module, configured to use each target reference sample whose difference measurement index calculated by the first calculation module is less than or equal to a preset threshold in all the reference samples as a comparison sample; a second calculation module, configured to calculate a similarity between each training sample in the training set and each comparison sample determined by the first determining module; a second determining module, configured to use a training sample whose similarity, calculated by the second calculation module, with the comparison sample meets a preset augmentation condition as a to-be-augmented sample; and an augmentation module, configured to perform data augmentation on the to-be-augmented sample determined by the second determining module to obtain a target training sample; where the training module is configured to retrain the trained deep neural network model by using the target training sample augmented by using the augmentation sample as a training sample in the training set until model prediction values of all verification samples in the verification set meet a preset training ending condition.

A computer device, including: a memory, a processor, and computer-readable instructions that are stored in the memory and can be run on the processor, where when the processor executes the computer-readable instructions, the steps corresponding to the foregoing neural network model training method are implemented.

One or more non-volatile readable storage mediums storing computer-readable instructions are provided, where when the computer-readable instructions are executed by one or more processors, the one or more processors are enabled to perform the steps corresponding to the foregoing neural network model training method.

Details of one or more embodiments of this application are set forth in accompanying drawings and description below, and other features and advantages of this application become apparent from the specification, accompanying drawings and claims.

### BRIEF DESCRIPTION OF THE DRAWINGS

In order to explain technical solutions of embodiments of this application more clearly, the following briefly introduces the accompanying drawings required to be used in the description of the embodiments of this application. Apparently, the accompanying drawings in the following description are only some embodiments of this application, and a person of ordinary skill in the art can further obtain other accompanying drawings based on these accompanying drawings without creative efforts.

FIG. 1 is a schematic architectural diagram of a neural network model training method according to this application;

FIG. 2 is a schematic flowchart of an embodiment of a neural network model training method according to this application;

FIG. 3 is a schematic flowchart of an embodiment of a neural network model training method according to this application;

FIG. 4 is a schematic flowchart of an embodiment of a neural network model training method according to this application;

FIG. 5 is a schematic flowchart of an embodiment of a neural network model training method according to this application;

FIG. 6 is a schematic flowchart of an embodiment of a neural network model training method according to this application;

FIG. 7 is a schematic structural diagram of an embodiment of a neural network model training apparatus according to this application; and

FIG. 8 is a schematic structural diagram of a computer device according to this application.

### DETAILED DESCRIPTION OF THE EMBODIMENTS

The following clearly and completely describes the technical solutions in the embodiments of this application with reference to the accompanying drawings in the embodiments of this application. Obviously, the described embodiments are merely some rather than all embodiments of this application. All the other embodiments obtained by a person of ordinary skill in the art based on the embodiments of this application without any creative efforts shall fall within the protection scope of the embodiments of this application.

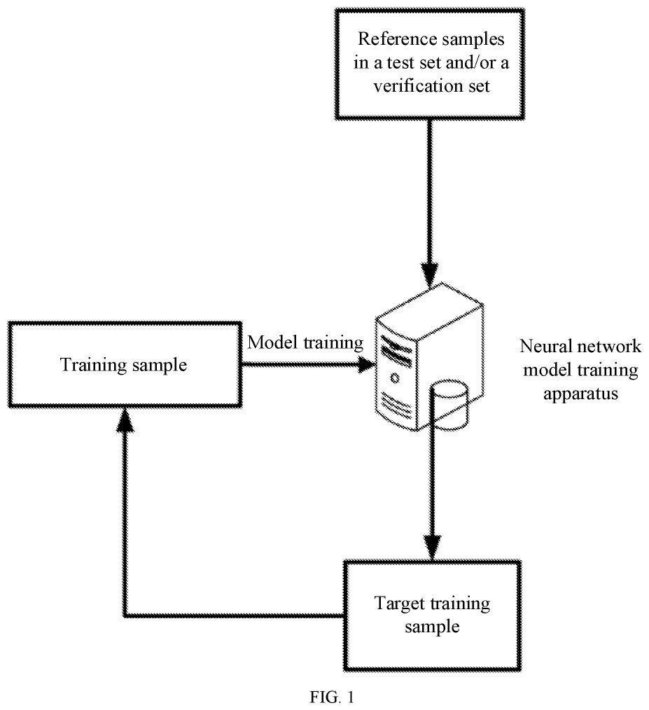

This application provides a neural network model training method, which can be applied to a schematic architectural diagram shown in FIG. 1. A neural network model training apparatus can be implemented by using an independent server or a server cluster formed by a plurality of servers, or the neural network model training apparatus can be implemented as an independent apparatus or integrated in the foregoing server. This is not limited herein. The server may obtain a training sample in a training set for model training and a reference sample, and train a deep neural network model based on the training sample in the training set to obtain a trained deep neural network model; perform data verification on all reference samples in a reference set based on the trained deep neural network model to obtain a model prediction value of each of all the reference samples, where the reference set includes a verification set and/or a test set; calculate a difference measurement index between the model prediction value of each reference sample and a real annotation corresponding to the reference sample; use each target reference sample whose difference measurement index is less than or equal to a preset threshold in all the reference samples as a comparison sample; calculate a similarity between each training sample in the training set and each comparison sample; use a training sample whose similarity with the comparison sample meets a preset augmentation condition as a to-be-augmented sample; perform data augmentation on the to-be-augmented sample to obtain a target training sample; and train the trained deep neural network model by using the target training sample as a training sample in the training set until model prediction values of all verification samples in the verification set meet a preset training ending condition. As can be seen from the foregoing solution, because pertinent augmented sample data is selected, the training sample data for model training is augmented, and prediction results of the samples in the test set and/or the verification set are used for model training, so that the verification set and the test set are directly involved in model training. Missing samples, that is, hard samples, in the model training process are directly analyzed based on the results, so that pertinent training samples are selected, thereby improving pertinence and training efficiency of model training. This application is described in detail below:

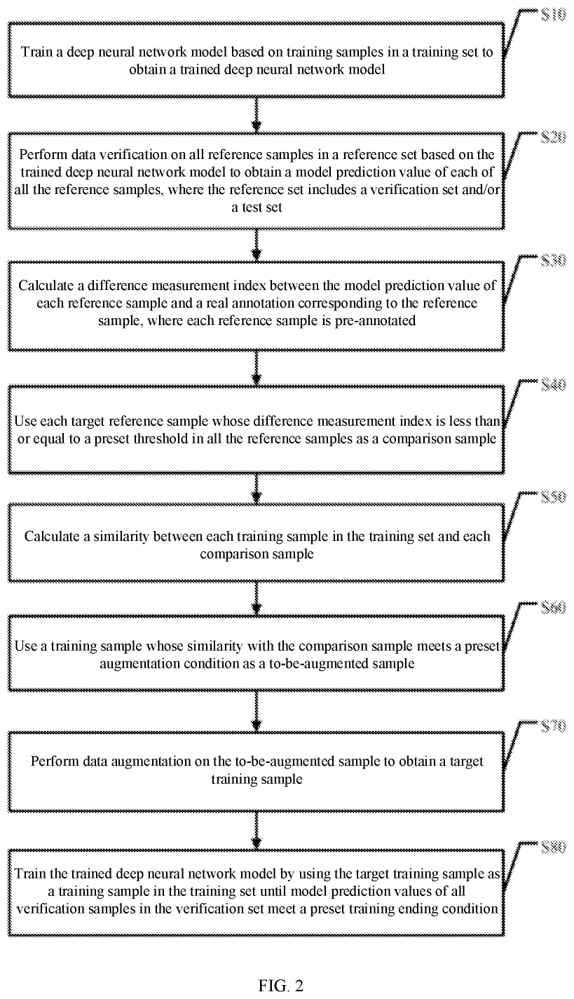

FIG. 2 is a schematic flowchart of an embodiment of a deep neural network model training method according to this application. The method includes the following steps:

S10: Train a deep neural network model based on training samples in a training set to obtain a trained deep neural network model.

The training set is a basis for training the deep neural network model. The deep neural network model can be imagined as a powerful nonlinear fitter for fitting data in the training set, that is, training samples. Therefore, after the training set is prepared, the deep neural network model can be trained based on the training samples in the training set to obtain the trained deep neural network model. It should be noted that the foregoing deep neural network model refers to a convolutional neural network model, or may be a recurrent neural network model, or may be another type of convolutional neural network model. This is not limited in this embodiment of this application. In addition, the training process is an effectively supervised training process, and the training samples in the training set are pre-annotated. For example, in order to train a deep neural network model for image classification, a training sample is annotated with an image category, so as to train a deep neural network model for image classification, such as a deep neural network model for classifying a lesion image.

Specifically, in this embodiment of this application, a training period (epoch) may be preset. For example, 10 epochs may be used as a complete training period. In each epoch, the deep neural network model is trained once based on all training samples in the training set. In 10 epochs, the deep neural network model is trained 10 times based on all the training samples in the training set. It should be noted that the specific number of epochs is not limited in this embodiment of this application. For example, eight epochs may also be used as a complete training period.

S20: Perform data verification on all reference samples in a reference set based on the trained deep neural network model to obtain a model prediction value of each of all the reference samples, where the reference set includes a verification set and/or a test set.

The verification set refers to sample data used for evaluating validity of the deep neural network model throughout the training process in this embodiment of this application. When the deep neural network model is trained to a certain extent, the deep neural network model is verified by using the sample data in the verification set to prevent the deep neural network model from being over-fitted. Therefore, the sample data in the verification set is indirectly used in the model training process, and the verification result can be used to determine whether a current training state of the deep neural network model is valid for data beyond the training set. The test set is sample data finally used to evaluate accuracy of the deep neural network model.

In this embodiment of this application, the verification set and/or the test set described above are/is used as reference sets/a reference set, and the sample data in the verification set and/or the test set is used as reference samples in the reference set. For example, a trained deep neural network model can be obtained after training for every 10 epochs; and then data verification is performed on all reference samples in the reference set based on the trained deep neural network model, so as to obtain a model prediction value of each of all the reference samples. It should be noted that the model prediction value refers to a verification result generated during verification of a reference sample based on a deep neural network model after a certain training period. For example, if the deep neural network model is used for image classification, the model prediction value is used to represent accuracy of image classification.

S30: Calculate a difference measurement index between the model prediction value of each reference sample and a real annotation corresponding to the reference sample, where each reference sample is pre-annotated.

After the model prediction value of each of all the reference samples is obtained, the difference measurement index between the model prediction value of each of all the reference samples and a real annotation corresponding to the reference sample is calculated.

It can be understood that, as an effectively supervised training method, the sample data in the verification set or the test set is pre-annotated, that is, each reference sample corresponds to a real annotation. The difference measurement index is used to represent the degree of difference between the model prediction value of the reference sample and the real annotation corresponding to the reference sample. For example, for reference sample A, model prediction values predicted based on the deep neural network model are [0.8.5,0,0.2,0,0], and real annotations are [1,0,0,0,0]. Then, difference measurement indexes can be calculated based on the two sets of data, so as to obtain the differences between the model prediction values and the real annotations.

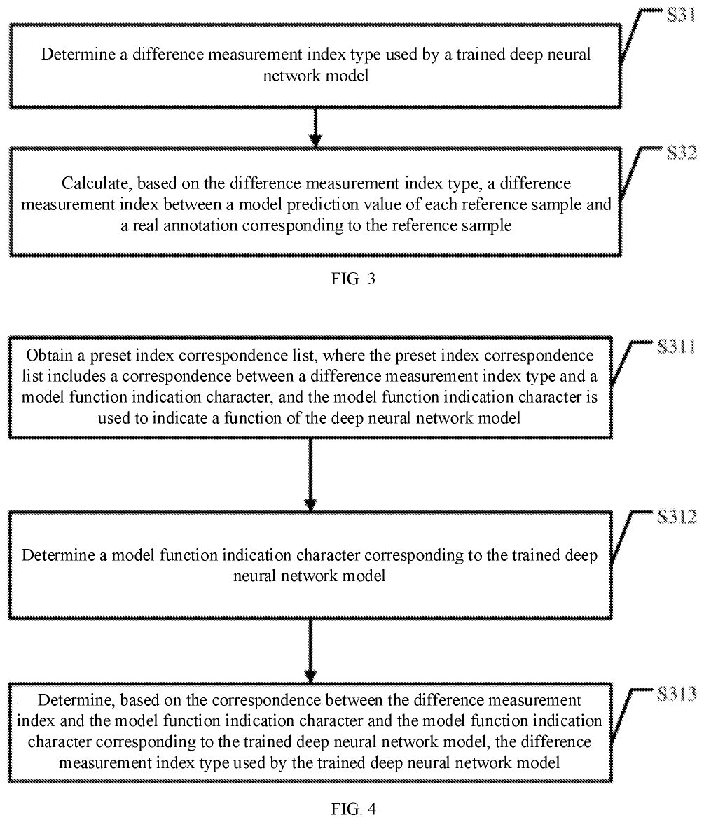

In an embodiment, as shown in FIG. 3, the calculating a difference measurement index between the model prediction value of each reference sample and a real annotation corresponding to the reference sample in step S30 includes the following steps:

S31: Determine a difference measurement index type used by the trained deep neural network model.

It should be understood that before the difference measurement index between the model prediction value of each reference sample and the real annotation corresponding to the reference sample is calculated based on the difference measurement index type, the difference measurement index type used by the trained deep neural network model needs to be determined first in this solution, depending on a function of the trained deep neural network model. The function of the deep neural network model means that the deep neural network model is used for image segmentation or image classification. A proper difference measurement index type needs to be selected based on the function of the deep neural network model.

In an embodiment, as shown in FIG. 4, the determining a difference measurement index type used by the trained deep neural network model in step S31 includes the following steps:

S311: Obtain a preset index correspondence list, where the preset index correspondence list includes a correspondence between a difference measurement index type and a model function indication character, and the model function indication character is used to indicate a function of the deep neural network model.

The model function indication character may indicate the function of the deep neural network model, and may be customized as a number, a letter, or the like. This is not limited herein. Specifically, the difference measurement index type includes a cross entropy coefficient, a Jaccard coefficient, and a dice coefficient, where a model function indication character indicating an image classification function of the deep neural network model corresponds to the cross entropy coefficient, and a model function indication character indicating an image segmentation function of the deep neural network model corresponds to the Jaccard coefficient or the dice coefficient.

S312: Determine a model function indication character corresponding to the trained deep neural network model.

S313: Determine, based on the correspondence between the difference measurement index and the model function indication character and the model function indication character corresponding to the trained deep neural network model, the difference measurement index type used by the trained deep neural network model.

For steps S312 and S313, it can be understood that after the preset index correspondence list is obtained, the correspondence relationship between the difference measurement index and the model function indication character can be determined based on the preset index correspondence list. Therefore, the difference measurement index type used by the trained deep neural network model can be determined based on the model function indication character corresponding to the trained deep neural network model.

S32: Calculate, based on the difference measurement index type, the difference measurement index between the model prediction value of each reference sample and the real annotation corresponding to the reference sample.

For example, assuming that the deep neural network model in this embodiment of this application is used for image classification, the cross entropy coefficient may be used as a difference measurement index between a model prediction value of each reference sample and a real annotation corresponding to the reference sample.

Assuming that current distribution of the real annotation of a reference sample is p(x) and the model prediction value of the reference sample is q(x), that is, prediction distribution of the trained deep neural network model is q(x), the cross entropy H(p, q) between the real annotation and the model prediction value can be calculated by using the following formula:

$$H ( p , q ) = {\sum }_{x} p ( x ) •log ( \frac{1}{q ( x )} ) ;$$

It should be noted that, assuming that the deep neural network model in this embodiment of this application is used for image segmentation, then the Jaccard coefficient or the dice coefficient between the real annotation and the model prediction value is calculated and used as the difference measurement index between the real annotation and the model prediction value. A specific calculation process is not described in detail herein.

S40: Use each target reference sample whose difference measurement index is less than or equal to a preset threshold in all the reference samples as a comparison sample.

It can be understood that, after step S30, a difference measurement index corresponding to each of all the reference samples in the reference set can be obtained. In this embodiment of this application, each target reference sample whose difference measurement index is less than or equal to the preset threshold in all the reference samples is used as a comparison sample for subsequent calculation of a similarity with a training sample. It can be understood that each obtained comparison sample is a hard sample, and one or more comparison samples may be obtained, depending on a training situation of the deep neural network model. It should be noted that the preset threshold is determined based on a project requirement or actual experience, and is not specifically limited herein. For example, the preset threshold may be set to 0.7 when the deep neural network model is used for image segmentation.

S50: Calculate a similarity between each training sample in the training set and each comparison sample.

After one or more comparison samples are obtained, a similarity between each training sample in the training set and each comparison sample is calculated. For ease of understanding, a simple example is given here. For example, assuming that there are three comparison samples and 10 training samples, the similarity between each comparison sample and each of the 10 training samples can be calculated; that is, a total of 30 similarities can be obtained.

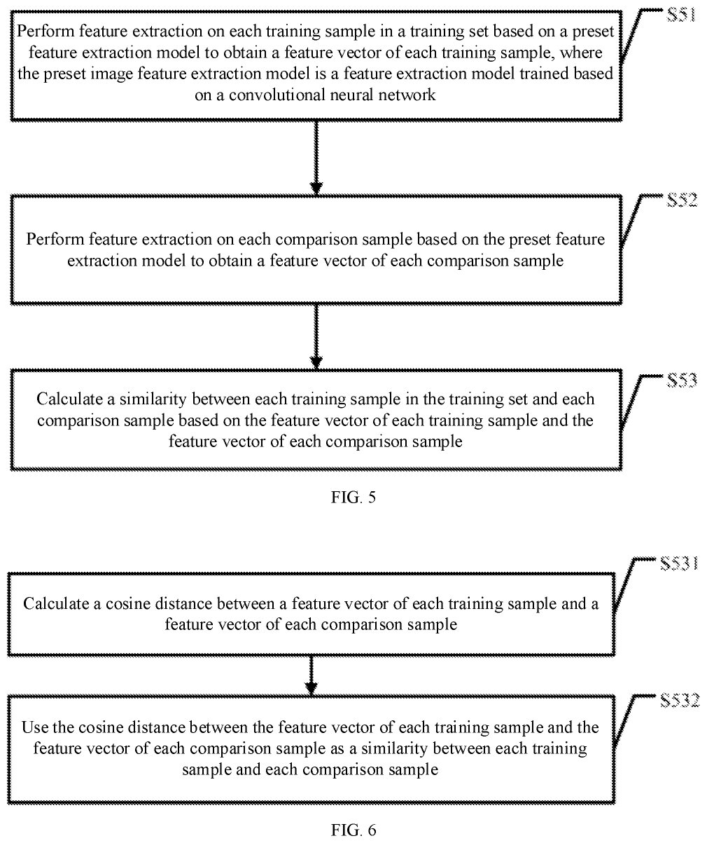

In an embodiment, as shown in FIG. 5, the calculating a similarity between each training sample in the training set and each comparison sample in step S50 includes the following steps:

S51: Perform feature extraction on each training sample in the training set based on a preset feature extraction model to obtain a feature vector of each training sample, where the preset feature extraction model is a feature extraction model trained based on a convolutional neural network.

S52: Perform feature extraction on the comparison sample based on the preset feature extraction model to obtain a feature vector of each comparison sample.

S53: Calculate the similarity between each training sample in the training set and each comparison sample based on the feature vector of each training sample and the feature vector of each comparison sample.

For steps S51-S53, the similarities between the training samples in the training set and the comparison samples are calculated based on the feature vectors in this embodiment of this application. The image feature vector extraction based on the convolutional neural network and validity of the images finally found by using different image similarity algorithms are different, so that the pertinent images are obtained. This is beneficial to model training.

In an embodiment, as shown in FIG. 6, the calculating the similarity between each training sample in the training set and each comparison sample based on the feature vector of each training sample and the feature vector of each comparison sample in step S53 includes the following steps:

S531: Calculate a cosine distance between the feature vector of each training sample and the feature vector of each comparison sample.

S532: Use the cosine distance between the feature vector of each training sample and the feature vector of each comparison sample as the similarity between each training sample and each comparison sample.

For steps S531 and S532, it can be understood that in addition to the similarity between the training sample and the comparison sample that is represented by the cosine distance, a Euclidean distance, a Manhattan distance, and the like obtained based on the feature vector of each training sample and the feature vector of each comparison sample may be calculated to represent the foregoing similarity. This is not limited in this embodiment of this application. The cosine similarity calculation method is used as an example herein. Assuming that the feature vector corresponding to each training sample is x [symbol] ,i ∈(1,2, . . . , n), and the feature vector corresponding to each comparison sample is y [symbol] ,i ∈(1,2, . . . , n), where n is a positive integer, then the cosine distance between the feature vector of each training sample and the feature vector of each comparison sample is

$$cos ( θ ) = \frac{{\sum }_{i = 1}^{n} ( {x}_{i} \times {y}_{i} )}{\sqrt{{\sum }_{i = 1}^{n} {( {x}_{i} )}^{2}} \times \sqrt{{\sum }_{i = 1}^{n} {( {y}_{i} )}^{2}}} .$$

S60: Use a training sample whose similarity with the comparison sample meets a preset augmentation condition as a to-be-augmented sample.

After the similarity between each training sample in the training set and each comparison sample is calculated, a training sample whose similarity with the comparison sample meets the preset augmentation condition is used as a to-be-augmented sample. It should be noted that the preset augmentation condition may be adjusted based on an actual application scenario. For example, if the similarities between the training samples in the training set and the comparison samples rank top 3, the training samples ranked top 3 meet the predetermined augmentation condition. For example, there is a comparison sample 1 and a comparison sample 2, the similarities between the comparison sample 1 and each training sample in the training set are calculated, and the training samples whose similarities with the comparison sample 1 rank top 3 are used as to-be-augmented samples. Similarly, the similarities between the comparison sample 2 and each training sample in the training set are calculated, and the training samples whose similarities with the comparison sample 2 rank top 3 are used as to-be-augmented samples. For another comparison sample, the to-be-augmented samples can be determined in a similar manner. As such, the to-be-augmented samples can be determined for each comparison sample. It can be understood that the obtained to-be-augmented samples is a set of samples that are most similar to the comparison sample.

It can be seen that, based on different application scenarios, the global highest similarity and the local highest similarity can be found to meet requirements, and in the whole process, no sample needs to be manually observed and selected. Therefore, this screening mechanism is efficient.

S70: Perform data augmentation on the to-be-augmented sample to obtain a target training sample.

After the training sample whose similarity with the comparison sample meets the preset augmentation condition is obtained as a to-be-augmented sample, data augmentation is performed on the to-be-augmented sample to obtain a target training sample. It should be noted that in this embodiment of this application, a conventional image augmentation method may be used to perform uniform data augmentation on the determined to-be-augmented samples. For example, the to-be-augmented sample may be augmented through double data enhancement (for example, rotation, translation, or zooming), and the augmented sample is the target training sample. The total data gain can be reduced herein, and the gain can be obtained only for a small part of data, so that the efficiency of model training can be improved.

S80: Train the trained deep neural network model by using the target training sample as a training sample in the training set until model prediction values of all verification samples in the verification set meet a preset training ending condition.

After the augmented sample (that is, the target training sample) is obtained, the target training sample is used as a training sample in the training set to train the trained deep neural network model until the model prediction values of all the verification samples in the verification set meet the preset training ending condition. That is, after the augmented target training sample is obtained, the target training sample is used as the sample data in the training set and the verification set to train the deep neural network model, and new rounds of training are performed again and again. Based on such operations, the result of the previous model prediction is used to optimize the result of the next model prediction, so that the performance of model prediction and the efficiency of model training are improved.

In an embodiment, for example, the target training samples are allocated to the training set and the verification set at a certain ratio, so that the allocation result is that the ratio of the samples in the training set to the samples in the verification set is at about 5:1 or another value. This is not limited herein.

In an embodiment, that the target training sample is used as a training sample in the training set to train the trained deep neural network model until the model prediction values of all the verification samples in the verification set meet the preset training ending condition includes: training the trained deep neural network model by using the target training sample as a training sample in the training set until a corresponding difference measurement index of each of all the verification samples in the verification set is less than or equal to the preset threshold. In addition, there may be another preset training ending condition, for example, the number of training iterations of the model has reached a preset upper limit. This is not specifically limited herein.

It should be understood that the sequence number of each step in the foregoing embodiments does not mean the order of execution. The order of execution of each process should be determined by functions and internal logic thereof, and should not constitute any limitation on the implementation process of this embodiment of this application.

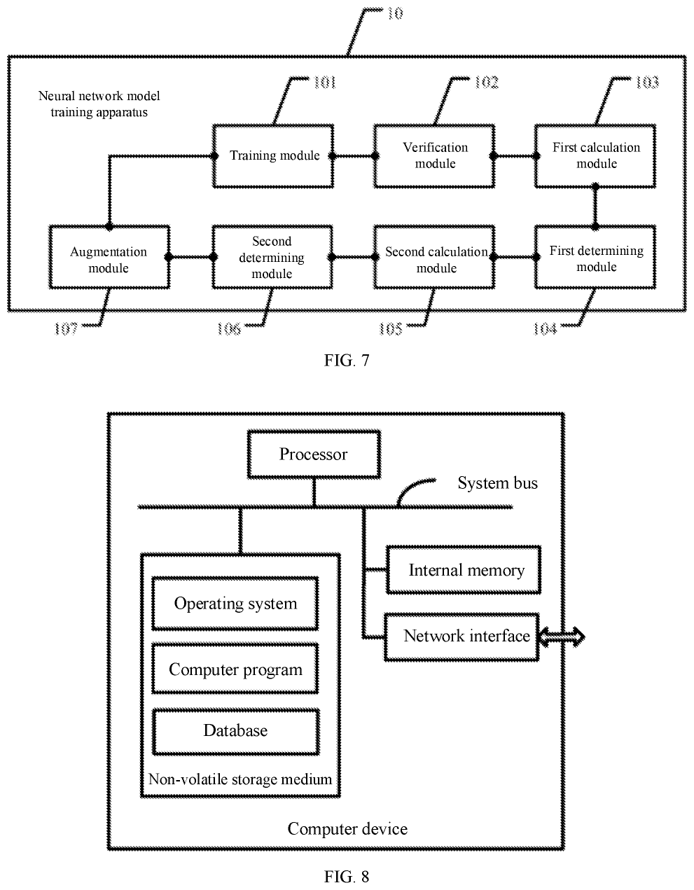

In an embodiment, a neural network model training apparatus is provided, where the neural network model training apparatus corresponds to the neural network model training method in the foregoing embodiment. As shown in FIG. 7, the neural network model training apparatus 10 includes a training module 101, a verification module 102, a first calculation module 103, a first determining module 104, a second calculation module 105, a second determining module 106, and an augmentation module 107. The functional modules are described in detail below. The training module 101 is configured to train a deep neural network model based on training samples in a training set to obtain a trained deep neural network model. The verification module 102 is configured to perform, based on the trained deep neural network model obtained by the training module 101, data verification on all reference samples in a reference set to obtain a model prediction value of each of all the reference samples, where the reference set includes a verification set and/or a test set. The first calculation module 103 is configured to calculate a difference measurement index between the model prediction value of each reference sample obtained by the verification module 102 and a real annotation corresponding to the reference sample, where each reference sample is pre-annotated. The first determining module 104 is configured to use each target reference sample whose difference measurement index calculated by the first calculation module 103 is less than or equal to a preset threshold in all the reference samples as a comparison sample. The second calculation module 105 is configured to calculate a similarity between each training sample in the training set and each comparison sample determined by the first determining module 104. The second determining module 106 is configured to use a training sample whose similarity, calculated by the second calculation module 105, with the comparison sample meets a preset augmentation condition as a to-be-augmented sample. The augmentation module 107 is configured to perform data augmentation on the to-be-augmented sample determined by the second determining module 106 to obtain a target training sample. The training module 101 is configured to retrain the trained deep neural network model by using the target training sample augmented by using the augmentation sample as a training sample in the training set until model prediction values of all verification samples in the verification set meet a preset training ending condition.

In an embodiment, that the training module 101 is configured to train the trained deep neural network model by using the target training sample as a training sample in the training set until model prediction values of all verification samples in the verification set meets a preset training ending condition specifically includes: The training module 101 is configured to train the trained deep neural network model by using the target training sample as a training sample in the training set until a corresponding difference measurement index of each of all the verification samples in the verification set is less than or equal to the preset threshold.

In an embodiment, the first calculation module 103 is specifically configured to: determine a difference measurement index type used by the trained deep neural network model; and calculate, based on the difference measurement index type, the difference measurement index between the model prediction value of each reference sample and the real annotation corresponding to the reference sample.

In an embodiment, that the first calculation module 103 is configured to determine a difference measurement index type used by the trained deep neural network model specifically includes: The first calculation module 103 is specifically configured to: obtain a preset index correspondence list, where the preset index correspondence list includes a correspondence between the difference measurement index type and a model function indication character, and the model function indication character is used to indicate a function of the deep neural network model; determine a model function indication character corresponding to the trained deep neural network model; and determine, based on the correspondence between the difference measurement index and the model function indication character and the model function indication character corresponding to the trained deep neural network model, the difference measurement index type used by the trained deep neural network model.

In an embodiment, the difference measurement index type includes a cross entropy coefficient, a Jaccard coefficient, and a dice coefficient, where a model function indication character indicating an image classification of the deep neural network model corresponds to the cross entropy coefficient, and a model function indication character indicating an image segmentation of the deep neural network model corresponds to the Jaccard coefficient or the dice coefficient.

In an embodiment, the second calculation module 105 is specifically configured to: perform feature extraction on each training sample in the training set based on a preset feature extraction model to obtain a feature vector of each training sample, where the preset feature extraction model is a feature extraction model trained based on a convolutional neural network; perform feature extraction on the comparison sample based on the preset feature extraction model to obtain a feature vector of each comparison sample; and calculate the similarity between each training sample in the training set and each comparison sample based on the feature vector of each training sample and the feature vector of each comparison sample.

In an embodiment, that the second calculation module 105 is configured to calculate the similarity between each training sample in the training set and each comparison sample based on the feature vector of each training sample and the feature vector of each comparison sample includes:

The second calculation module 105 is configured to: calculate a cosine distance between the feature vector of each training sample and the feature vector of each comparison sample; and use the cosine distance between the feature vector of each training sample and the feature vector of each comparison sample as the similarity between each training sample and each comparison sample.

For a specific definition of the neural network training apparatus, reference may be made to the definition of the foregoing neural network training method. Details are not described herein again. Various modules in the foregoing neural network training apparatus may be implemented fully or partially through software, hardware, and a combination thereof. Each of the foregoing modules may be embedded in or independent of a processor in a computer device in the form of hardware, or may be stored in a memory in the computer device in the form of software to enable the processor to conveniently invoke and execute operations corresponding to each of the foregoing modules.

In an embodiment, a computer device is provided. The computer device may be a server. An internal structure of the computer device may be shown in FIG. 8. The computer device includes a processor, a memory, a network interface and a database which are connected through a system bus. The processor of the computer device is configured to provide computing and control capabilities. The memory of the computer device includes a non-volatile storage medium and an internal memory. The non-volatile storage medium stores an operating system, a computer program, and a database. The internal memory provides an environment for operations of the operating system and the computer program in the non-volatile storage medium. The database of the computer device is used to temporarily store training samples, reference samples, and the like. The network interface of the computer device is configured to communicate with an external terminal through a network connection. The computer program is executed by the processor to implement a neural network training method.

In an embodiment, a computer device is provided, including a memory, a processor, and computer-readable instructions that are stored on the memory and can be run on the processor. When the computer-readable instructions are executed by the processor, the processor performs the following steps: training a deep neural network model based on training samples in a training set to obtain a trained deep neural network model; performing data verification on all reference samples in a reference set based on the trained deep neural network model to obtain a model prediction value of each of all the reference samples, where the reference set includes a verification set and/or a test set; calculating a difference measurement index between the model prediction value of each reference sample and a real annotation corresponding to the reference sample, where each reference sample is pre-annotated; using each target reference sample whose difference measurement index is less than or equal to a preset threshold in all the reference samples as a comparison sample; calculating a similarity between each training sample in the training set and each comparison sample; using a training sample whose similarity with the comparison sample meets a preset augmentation condition as a to-be-augmented sample; performing data augmentation on the to-be-augmented sample to obtain a target training sample; and training the trained deep neural network model by using the target training sample as a training sample in the training set until model prediction values of all verification samples in the verification set meet a preset training ending condition.

In an embodiment, one or more non-volatile readable storage mediums storing computer-readable instructions are provided. When the computer-readable instructions are executed by one or more processors, the one or more processors perform the following steps: training a deep neural network model based on training samples in a training set to obtain a trained deep neural network model; performing data verification on all reference samples in a reference set based on the trained deep neural network model to obtain a model prediction value of each of all the reference samples, where the reference set includes a verification set and/or a test set; calculating a difference measurement index between the model prediction value of each reference sample and a real annotation corresponding to the reference sample, where each reference sample is pre-annotated; using each target reference sample whose difference measurement index is less than or equal to a preset threshold in all the reference samples as a comparison sample; calculating a similarity between each training sample in the training set and each comparison sample; using a training sample whose similarity with the comparison sample meets a preset augmentation condition as a to-be-augmented sample; performing data augmentation on the to-be-augmented sample to obtain a target training sample; and training the trained deep neural network model by using the target training sample as a training sample in the training set until model prediction values of all verification samples in the verification set meet a preset training ending condition.

A person of ordinary skill in the art can understand that all or some of processes for implementing the methods in the foregoing embodiments may be implemented by instructing related hardware by using a computer program. The computer program may be stored in a non-volatile computer-readable storage medium. The processes of the methods in the embodiments described above may be performed when the computer program is executed. Any reference to a memory, storage, a database, or other media used in the embodiments provided in this application may include a non-volatile memory and/or a volatile memory. The non-volatile memory may include a read-only memory (ROM), a programmable ROM (PROM), an electrically programmable ROM (EPROM), an electrically erasable programmable ROM (EEPROM), or a flash memory. The volatile memory may include a Random Access Memory (RAM) or an external cache memory. As description rather than limitation, the RAM can be obtained in a plurality of forms, such as a static RAM (SRAM), a dynamic RAM (DRAM), a synchronous DRAM (SDRAM), a double data rate SDRAM (DDRSDRAM), an enhanced SDRAM (ESDRAM), a Synchlink DRAM (SLDRAM), a Rambus direct RAM (RDRAM), a direct Rambus dynamic RAM (DRDRAM), and a Rambus dynamic RAM (RDRAM).

It can be clearly understood by those skilled in the art that, for convenience and brevity of description, only the division of the foregoing function units and modules is exemplified. In practical applications, the foregoing functions may be assigned to different function units and modules for implementation as required. That is, the internal structure of the apparatus is divided into different function units or modules to implement all or some of the functions described above.

The foregoing embodiments are only used to explain the technical solutions of this application, and are not intended to limit the same. Although the embodiments of this application have been described in detail with reference to the foregoing embodiments, those of ordinary skill in the art should understand that they can still modify the technical solutions described in the foregoing embodiments, or make equivalent replacements on some technical features therein. These modifications or replacements do not make the essence of the corresponding technical solutions depart from the spirit and scope of the technical solutions of the embodiments of this application, and shall fall within the protection scope of the embodiments of this application.

What is claimed is:

1. A neural network model training method, comprising the steps of:
training a deep neural network model based on training samples in a training set to obtain a trained deep neural network model;
performing a data verification on each reference sample of reference samples in a reference set based on the trained deep neural network model to obtain a model prediction value of the each reference sample, wherein the reference set comprises at least one selected from the group consisting of a verification set and a test set;
calculating a difference measurement index between the model prediction value of the each reference sample and a real annotation corresponding to the each reference sample, wherein the each reference sample is pre-annotated;
using each target reference sample of the reference samples as a comparison sample, wherein the difference measurement index of the each target reference sample is less than or equal to a preset threshold;
calculating a similarity between each training sample of the training samples in the training set and the comparison sample;
using a predetermined training sample as a to-be-augmented sample, wherein the similarity between the predetermined training sample and the comparison sample meets a preset augmentation condition;
performing a data augmentation on the to-be-augmented sample to obtain a target training sample; and
training the trained deep neural network model by using the target training sample as a training sample in the training set until model prediction values of verification samples in the verification set meet a preset training ending condition.

2. The neural network model training method according to claim 1, wherein the step of training the trained deep neural network model by using the target training sample as the training sample in the training set until the model prediction values of the verification samples in the verification set meet the preset training ending condition comprises:
training the trained deep neural network model by using the target training sample as the training sample in the training set until a difference measurement index of each of the verification samples in the verification set is less than or equal to the preset threshold.

3. The neural network model training method according to claim 1, wherein the step of calculating the difference measurement index between the model prediction value of the each reference sample and the real annotation corresponding to the each reference sample comprises the steps of:
determining a difference measurement index type used by the trained deep neural network model; and
calculating, based on the difference measurement index type, the difference measurement index between the model prediction value of the each reference sample and the real annotation corresponding to the each reference sample.

4. The neural network model training method according to claim 3, wherein the step of determining the difference measurement index type used by the trained deep neural network model comprises:
obtaining a preset index correspondence list, wherein the preset index correspondence list comprises a correspondence between the difference measurement index type and a model function indication character, and the model function indication character is used to indicate a function of the trained deep neural network model;
determining the model function indication character corresponding to the trained deep neural network model; and
determining, based on the correspondence between the difference measurement index type and the model function indication character and the model function indication character corresponding to the trained deep neural network model, the difference measurement index type used by the trained deep neural network model.

5. The neural network model training method according to claim 4, wherein the difference measurement index type comprises a cross entropy coefficient, a Jaccard coefficient, and a dice coefficient, wherein a model function indication character indicating an image classification function of the trained deep neural network model corresponds to the cross entropy coefficient, and a model function indication character indicating an image segmentation function of the trained deep neural network model corresponds to the Jaccard coefficient or the dice coefficient.

6. The neural network model training method according to claim 1, wherein the step of calculating the similarity between the each training sample in the training set and the comparison sample comprises the steps of:
performing a feature extraction on the each training sample in the training set based on a preset feature extraction model to obtain a feature vector of the each training sample, wherein the preset feature extraction model is trained based on a convolutional neural network;
performing the feature extraction on the comparison sample based on the preset feature extraction model to obtain a feature vector of the comparison sample; and
calculating the similarity between the each training sample in the training set and the comparison sample based on the feature vector of the each training sample and the feature vector of the comparison sample.

7. The neural network model training method according to claim 6, wherein the step of calculating the similarity between the each training sample in the training set and the comparison sample based on the feature vector of the each training sample and the feature vector of the comparison sample comprises:
calculating a cosine distance between the feature vector of the each training sample and the feature vector of the comparison sample; and
using the cosine distance between the feature vector of the each training sample and the feature vector of the comparison sample as the similarity between the each training sample and the comparison sample.

8-10. (canceled)

11. A computer device, comprising a memory, a processor, and computer-readable instructions stored in the memory and configured to run on the processor, wherein when the processor executes the computer-readable instructions, the following steps are implemented:
training a deep neural network model based on training samples in a training set to obtain a trained deep neural network model;
performing a data verification on each reference sample of reference samples in a reference set based on the trained deep neural network model to obtain a model prediction value of the each reference sample, wherein the reference set comprises at least one selected from the group consisting of a verification set and a test set;
calculating a difference measurement index between the model prediction value of the each reference sample and a real annotation corresponding to the each reference sample, wherein the each reference sample is pre-annotated;
using each target reference sample of the reference samples as a comparison sample, wherein the difference measurement index of the each target reference sample is less than or equal to a preset threshold;
calculating a similarity between each training sample of the training samples in the training set and the comparison sample;
using a predetermined training sample as a to-be-augmented sample, wherein the similarity between the predetermined training sample and the comparison sample meets a preset augmentation condition;
performing a data augmentation on the to-be-augmented sample to obtain a target training sample; and
training the trained deep neural network model by using the target training sample as a training sample in the training set until model prediction values of verification samples in the verification set meet a preset training ending condition.

12. The computer device according to claim 11, wherein the processor executes the computer-readable instructions to train the trained deep neural network model by using the target training sample as the training sample in the training set until the model prediction values of the verification samples in the verification set meet the preset training ending condition, comprising the following steps:
training the trained deep neural network model by using the target training sample as the training sample in the training set until a difference measurement index of each of the verification samples in the verification set is less than or equal to the preset threshold.

13. The computer device according to claim 11, wherein the processor executes the computer-readable instructions to calculate the difference measurement index between the model prediction value of the each reference sample and the real annotation corresponding to the the each reference sample, comprising the following steps:
determining a difference measurement index type used by the trained deep neural network model; and
calculating, based on the difference measurement index type, the difference measurement index between the model prediction value of the each reference sample and the real annotation corresponding to the each reference sample.

14. The computer device according to claim 13, wherein the processor executes the computer-readable instructions to determine the difference measurement index type used by the trained deep neural network model, comprising the following steps:
obtaining a preset index correspondence list, wherein the preset index correspondence list comprises a correspondence between the difference measurement index type and a model function indication character, and the model function indication character is used to indicate a function of the trained deep neural network model;
determining the model function indication character corresponding to the trained deep neural network model; and
determining, based on the correspondence between the difference measurement index type and the model function indication character and the model function indication character corresponding to the trained deep neural network model, the difference measurement index type used by the trained deep neural network model.

15. The computer device according to claim 14, wherein the difference measurement index type comprises a cross entropy coefficient, a Jaccard coefficient, and a dice coefficient, wherein a model function indication character indicating an image classification function of the trained deep neural network model corresponds to the cross entropy coefficient, and a model function indication character indicating an image segmentation function of the trained deep neural network model corresponds to the Jaccard coefficient or the dice coefficient.

16. A non-volatile readable storage medium storing computer-readable instructions, wherein when the computer-readable instructions are executed by one or more processors, the one or more processors perform the following steps:
training a deep neural network model based on training samples in a training set to obtain a trained deep neural network model;
performing a data verification on each reference sample of reference samples in a reference set based on the trained deep neural network model to obtain a model prediction value of the each reference sample, wherein the reference set comprises at least one selected from the group consisting of a verification set and a test set;
calculating a difference measurement index between the model prediction value of the each reference sample and a real annotation corresponding to the each reference sample, wherein the each reference sample is pre-annotated;
using each target reference sample of the reference samples as a comparison sample, wherein the difference measurement index of the each target reference sample is less than or equal to a preset threshold;
calculating a similarity between each training sample of the training samples in the training set and the comparison sample;
using a predetermined training sample a to-be-augmented sample, wherein the similarity between the predetermined training sample and the comparison sample meets a preset augmentation condition;
performing a data augmentation on the to-be-augmented sample to obtain a target training sample; and
training the trained deep neural network model by using the target training sample as a training sample in the training set until model prediction values of verification samples in the verification set meet a preset training ending condition.

17. The non-volatile readable storage medium according to claim 16, wherein when the computer-readable instructions run on a computer, the computer is configured to train the trained deep neural network model by using the target training sample as the training sample in the training set until the model prediction values of the verification samples in the verification set meet the preset training ending condition, comprising the following steps:
training the trained deep neural network model by using the target training sample as the training sample in the training set until a difference measurement index of each of the verification samples in the verification set is less than or equal to the preset threshold.

18. The non-volatile readable storage medium according to claim 16, wherein when the computer-readable instructions run on a computer, the computer is configured to calculate the difference measurement index between the model prediction value of the each reference sample and the real annotation corresponding to the each reference sample, comprising the following steps:
determining a difference measurement index type used by the trained deep neural network model; and
calculating, based on the difference measurement index type, the difference measurement index between the model prediction value of the each reference sample and the real annotation corresponding to the each reference sample.

19. The non-volatile readable storage medium according to claim 18, wherein when the computer-readable instructions run on a computer, the computer is configured to determine the difference measurement index type used by the trained deep neural network model, comprising the following steps:
obtaining a preset index correspondence list, wherein the preset index correspondence list comprises a correspondence between the difference measurement index type and a model function indication character, and the model function indication character is used to indicate a function of the trained deep neural network model;
determining the model function indication character corresponding to the trained deep neural network model; and
determining, based on the correspondence between the difference measurement index type and the model function indication character and the model function indication character corresponding to the trained deep neural network model, the difference measurement index type used by the trained deep neural network model.

20. The non-volatile readable storage medium according to claim 19, wherein the difference measurement index type comprises a cross entropy coefficient, a Jaccard coefficient, and a dice coefficient, wherein a model function indication character indicating an image classification function of the trained deep neural network model corresponds to the cross entropy coefficient, and a model function indication character indicating an image segmentation function of the trained deep neural network model corresponds to the Jaccard coefficient or the dice coefficient.

21. The computer device according to claim 11, wherein the processor executes the computer-readable instructions to calculate the similarity between the each training sample in the training set and the comparison sample, comprising the following steps:
performing a feature extraction on the each training sample in the training set based on a preset feature extraction model to obtain a feature vector of the each training sample, wherein the preset feature extraction model is trained based on a convolutional neural network;
performing the feature extraction on the comparison sample based on the preset feature extraction model to obtain a feature vector of the comparison sample; and
calculating the similarity between the each training sample in the training set and the comparison sample based on the feature vector of the each training sample and the feature vector of the comparison sample.

22. The computer device according to claim 21, wherein the processor executes the computer-readable instructions to calculate the similarity between the each training sample in the training set and the comparison sample based on the feature vector of the each training sample and the feature vector of the comparison sample, comprising the following steps:
calculating a cosine distance between the feature vector of the each training sample and the feature vector of the comparison sample; and
using the cosine distance between the feature vector of the each training sample and the feature vector of the comparison sample as the similarity between the each training sample and the comparison sample.

23. The non-volatile readable storage medium according to claim 16, wherein when the computer-readable instructions run on a computer, the computer is configured to calculate the similarity between the each training sample in the training set and the comparison sample, comprising the following steps:
performing a feature extraction on the each training sample in the training set based on a preset feature extraction model to obtain a feature vector of the each training sample, wherein the preset feature extraction model is trained based on a convolutional neural network;
performing the feature extraction on the comparison sample based on the preset feature extraction model to obtain a feature vector of the comparison sample; and
calculating the similarity between the each training sample in the training set and the comparison sample based on the feature vector of the each training sample and the feature vector of the comparison sample.
